(19) United States
(12) Patent Application Publication
(10) Pub. No.: US 2011/0012845 A1
(43) Pub. Date: Jan. 20, 2011

(54) TOUCH SENSOR STRUCTURES FOR DISPLAYS

(76) Inventors: Fletcher R. Rothkopf, Mountain View, CA (US); Stephen P. Zadesky, Portola Valley, CA (US); Richard Hung Minh Dinh, San Jose, CA (US)

Correspondence Address: Treyz Law Group, 870 Market Street, Suite 984, SAN FRANCISCO, CA, 94102, US

(21) Appl. No.: 12/615,191

(22) Filed: Nov. 9, 2009

Related U.S. Application Data
(60) Provisional application No. 61/227,054, filed on Jul. 20, 2009.

(51) Int. Cl. G06F 3/041

(52) U.S. Cl. 345/173

(57) ABSTRACT

An electronic device may have a touch screen display. The display may have a touch sensor structure that determines the location at which external objects touch the display. The touch sensor structure may have a clear substrate on which conductive capacitive touch sensor electrodes are formed. The electrodes may be formed from a transparent conductive material such as indium-tin oxide. The clear substrate may be formed from a flexible material such as a polymer. The polymer may be a clear polyimide. Copper traces or other conductive traces may be used to route sensor signals from the capacitive touch sensor electrodes to processing circuitry in the electronic device.

This application claims the benefit of provisional patent application No. 61/227,054, filed Jul. 20, 2009, which is hereby incorporated by reference herein in its entirety.

### BACKGROUND

This relates to electronic devices and, more particularly, to touch sensitive displays for electronic devices.

Electronic devices such as cellular telephones, handheld computers, and portable music players often include displays. A display includes an array of controllable pixels that are used to present visual information to a user. To protect a display from damage, the display may be mounted behind a protective layer of cover glass. The active portion of a display may be formed using backlit liquid crystal display (LCD) technology. Displays may also be formed using pixels based on organic light-emitting diode (OLED) technology.

It is often desirable to provide displays with touch sensor capabilities. For example, personal digital assistants have been provided with touch screens using resistive touch sensing technology. Touch screens of this type have a pair of opposing flexible plastic panels with respective sets of transparent electrodes. When touched by an object, the upper panel flexes into contact with the lower panel. This forces opposing electrodes into contact with each other and allows the location of the touch event to be detected.

Resistive touch screens can have undesirable attributes such as position-dependent sensitivity. Accordingly, many modern touch screens employ touch sensors based on capacitance sensing technology. In a capacitive touch screen, a capacitive touch sensor is implemented using an array of touch sensor electrodes. When a finger of a user or other external object is brought into the vicinity of the touch sensor electrodes, corresponding capacitance changes can be sensed and converted into touch location information.

In conventional capacitive touch screens, capacitive electrodes are formed on a glass substrate. The glass substrate is interposed between the active portion of the display and an outer cover glass. Although efforts are made to ensure that the glass substrate on which the capacitive electrodes are formed is not too thick, conventional glass substrates may still occupy about half of a millimeter in thickness. Particularly in modern devices in which excessive overall device thickness is a concern, the glass substrate thickness that is associated with conventional capacitive touch sensors can pose challenges.

It would therefore be desirable to be able to provide improved touch screens for electronic devices.

### SUMMARY

An electronic device may have a touch screen display. The display may have a touch sensor structure that determines the location at which external objects touch the display. The touch sensor structure may have a clear substrate on which conductive capacitive touch sensor electrodes are formed. The electrodes may be formed from a transparent conductive material such as indium-tin oxide. The clear substrate may be formed from a flexible material such as a polymer. The polymer may be a clear polyimide. Copper traces or other conductive traces may be used to route sensor signals from the capacitive touch sensor electrodes to processing circuitry in the electronic device over a flex circuit path that is formed as an integral part of the touch sensor structure.

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative electronic device with a touch screen in accordance with an embodiment of the present invention.

FIG. 2 is a cross-sectional side view of a touch screen coupled to storage and processing circuitry in accordance with an embodiment of the present invention.

FIG. 3A is a top view of a conventional touch sensor having capacitive electrodes formed on a glass substrate.

FIG. 3B is a cross-sectional side view of the conventional touch sensor of FIG. 3A.

FIG. 4 is a cross-sectional side view of a conventional touch screen having a touch sensor formed on a glass substrate of the type shown in FIGS. 3A and 3B.

FIG. 5A is a top view of an illustrative touch sensor having transparent capacitive electrodes formed on a polymer layer such as a layer of clear polyimide in accordance with an embodiment of the present invention.

FIG. 5B is a cross-sectional side view of a touch sensor array of the type shown in FIG. 5A coupled to a connector on a printed circuit board in accordance with an embodiment of the present invention.

FIG. 6 is a cross-sectional side view of a touch screen display having a touch sensor formed from a polymer substrate of the type shown in FIGS. 5A and 5B in accordance with an embodiment of the present invention.

FIG. 7 is a cross-sectional side view of a touch screen display in which adhesive has been used to couple a touch sensor array to a cover glass layer and a display module in accordance with an embodiment of the present invention.

FIGS. 8 and 9 are top views of illustrative layout patterns that may be used for transparent electrodes in a capacitive touch sensor array in accordance with an embodiment of the present invention.

FIGS. 10A and 10B are simplified cross-sectional views of an illustrative layered touch substrate in accordance with an embodiment of the present invention.

FIG. 11 is a simplified schematic diagram of an illustrative computing system that may include a touch sensitive input-output device in accordance with an embodiment of the present invention.

FIG. 12 is a schematic diagram of an illustrative computing system that may include a touch sensitive input-output device in accordance with an embodiment of the present invention.

FIG. 13 is a cross-sectional side view of a touch screen having a touch sensor formed from a polymer substrate that has a curved tail portion connected to a printed circuit board in accordance with an embodiment of the present invention.

### DETAILED DESCRIPTION

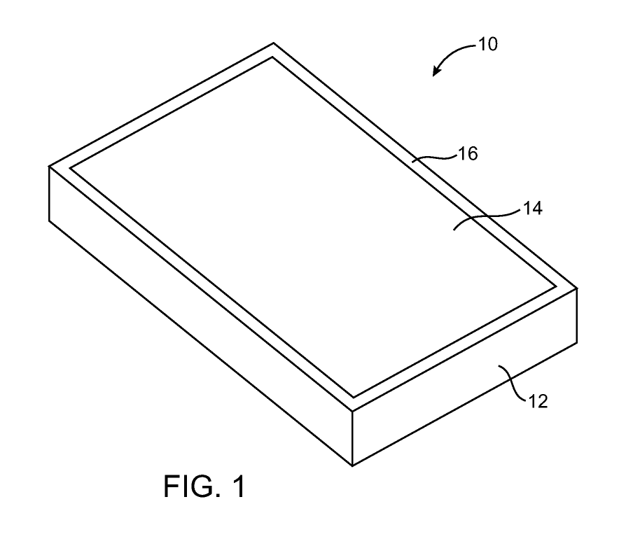

Electronic devices such as computers, handheld devices, computer monitors, televisions, cellular telephones, media players, and other equipment may have displays. An example is presented in FIG. 1. In the example of FIG. 1, device 10 is a portable device such as a portable media player, tablet computer, handheld electronic device, or cellular telephone. This is merely illustrative. Device 10 may, in general, be any suitable electronic device. The arrangement of FIG. 1 is an example.

As shown in FIG. 1, portable electronic device 10 may have housing 12. Housing 12, which is sometimes referred to as a case, may be formed from one or more individual structures. For example, housing 12 may have a main structural support member that is formed from a solid block of machined aluminum or other suitable metal. One or more additional structures may be connected to the housing 12. These structures may include, for example, internal frame members, external coverings such as sheets of metal, etc. Housing 12 and its associated components may, in general, be formed from any suitable materials such as plastic, ceramics, metal, glass, etc. Input-output ports such as an audio jack and data ports, user input interface components such as buttons, and other input-output devices may be provided in housing 12.

A display such as display 14 may be mounted within housing 12. Display 14 may be, for example, a liquid crystal display (LCD), an organic light emitting diode (OLED) display, or a plasma display (as examples). Touch sensor electrodes may be included in display 14 to provide display 14 with touch sensing capabilities (i.e., so that display 14 operates as a touch screen). Display 14 may contain a number of layers of material. For example, the outermost surface of display 14 may be protected using a layer of plastic or glass. This protective layer is sometimes referred to as a cover glass (whether formed from plastic, glass, or other transparent materials).

In the interior of device 10, display 14 may be provided with an array of controllable display pixels. In an LCD display, each display pixel is associated with a circuit that controls the polarization of a small volume of liquid crystal material. In light-emitting diode displays, each image pixel contains an individually controllable light-emitting diode.

The image pixels of display 14 may be formed as part of a display module. A liquid crystal display module may have layers of polarizer, light diffusing elements, light guides for backlight structures, and a liquid crystal layer with individual pixel-sized control elements. An organic light-emitting diode (OLED) display may have organic materials that are used in producing light. The outermost layer of the display module may be formed from a transparent material such as glass.

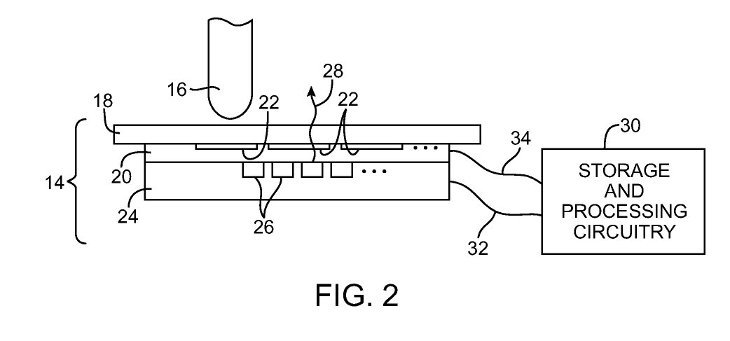

A cross-sectional view of display 14 of FIG. 1 and associated control circuitry is shown in FIG. 2. As shown in FIG. 2, display 14 may include a display module such as display module 24 that contains an array of image pixels 26. Display module 24 may be a liquid crystal display (LCD) display module, an organic light-emitting diode (OLED) display module, a plasma display module, or other suitable display that is capable of producing images. Each display pixel 26 may produce an individually controllable portion of an image (shown schematically as light signal 28).

The structures of display 14 may be protected using a protective cover such as cover glass 18. Cover glass 18 may be formed from a layer of glass, plastic, or other clear material. Cover glass 18 may, for example, be formed from a transparent layer of glass that is about 0.75 mm to 1 mm thick.

To provide display 14 with touch sensing capabilities and thereby allow display 14 to serve as a touch screen, an array of touch sensor electrodes may be interposed between display module 24 and cover glass 18. In the illustrative side view of FIG. 2, display 14 is shown as having a touch sensor structure 20 that includes an array of transparent electrodes 22. Touch sensor structure 20 may be formed on a planar dielectric member such as a layer of clear polymer flexible material. This planar member may serve as a substrate for touch sensor electrodes. The touch sensor electrodes may be formed from a transparent conductive material such as indium-tin oxide (ITO). If desired, other conductive materials may be used for forming electrodes in touch sensor structure 20. The use of an ITO electrode configuration is sometimes described herein as an example, but is merely illustrative.

Touch sensor electrodes 22 may be formed on one or both sides of the flexible substrate in touch sensor 20 and may have any suitable shapes. In a typical two-sided configuration, perpendicular elongated rectangular touch sensor electrodes 22 are formed on the top and bottom of the touch sensor substrate. In a typical single-sided configuration, square patches of transparent conductor may be used in forming the electrodes. Other configurations may also be used (e.g., single-sided arrangements based on diagonal electrode patterns, etc.).

The electronic device in which display 14 is mounted may contain storage and processing circuitry such as storage and processing circuitry 30. Display driver circuitry may be coupled to display module 24 using a path such as path 32. Path 32 may be used to route image data to display drivers in module 24. In response, image pixels 26 in module 24 are configured to display a desired image. Because the layers of material in touch sensor 20 and cover glass 18 are transparent, the image that is created by display 24 may be viewed by a user, as indicated schematically by light ray 28.

Storage and processing circuitry 30 may contain circuitry that measures and analyzes the capacitance of electrodes 22. This circuitry may be coupled to electrodes 22 using path 34. By monitoring the capacitances of electrodes 22, changes in capacitance can be measured. These changes in the capacitance associated with electrodes 22 can then be correlated with touch events. Capacitance changes can be detected when an external object is brought within the vicinity of touch sensor 20, so situations in which an external object comes into direct contact with cover glass 18 and situations in which an external object is merely brought into close proximity to cover glass 18 are both generally referred to as touch events.

FIG. 2 illustrates a typical touch event. As shown in the example of FIG. 2, a user's finger or other external object 16 may be brought into the vicinity of one or more electrodes 22. Path 34 and the capacitance sensing circuitry of storage and processing circuitry 30 can detect resulting changes in capacitance on these electrodes and can use these measured capacitance changes to determine the location of external object 16 on the surface of display 14. In a two-layer touch sensor, electrodes on both the upper and lower surfaces of the touch sensor substrate will generally exhibit capacitance changes. Because the electrodes are oriented at right angles to each other, the location of the touch event can be determined by determining the intersection point of the affected electrodes. A touch sensor with a single layer of touch sensor electrodes can determine the location of a touch event based on which individual electrode or sets of electrodes exhibit capacitance changes.

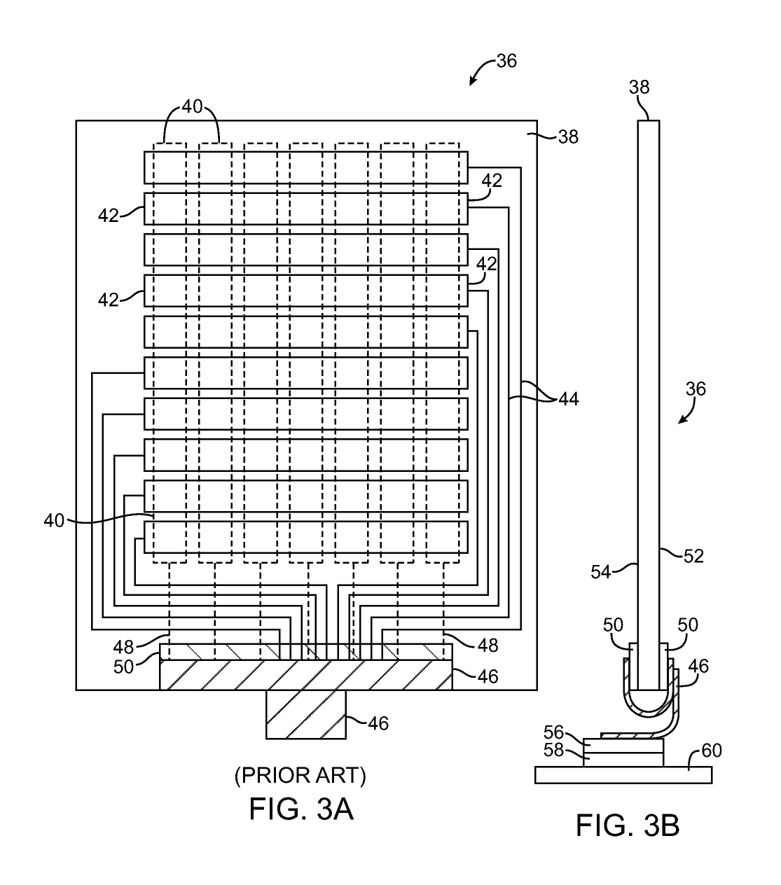

A conventional glass-based touch sensor structure of the type that may be interposed between a cover glass layer and liquid crystal display module in a portable media player is shown in FIG. 3A. As shown in FIG. 3A, touch screen structure 36 includes glass substrate 38. Glass substrate 38 is about 0.5 mm thick. Transparent electrodes 40 are formed in parallel vertical columns on the rear surface of glass substrate 38. Transparent electrodes 42 are formed in horizontal rows on the front surface of glass substrate 38 (when viewed from the top view orientation of FIG. 3A). Transparent electrodes 40 and 42 are oriented to run perpendicularly to each other, which allows processing circuitry to identify the location of a touch event from electrode capacitance measurements.

Transparent electrodes 40 and 42 are electrically connected to traces in flexible printed circuit 46 (sometimes referred to as a “flex circuit”) using conductive lines 44 on the front surface of glass substrate 38 and conductive lines 48 on the rear surface of glass substrate 38. Flexible printed circuit 46, which is formed from conventional colored polyimide, is used to couple the electrodes and traces on glass substrate 38 to processing circuitry located on system board 60 (FIG. 3B). Flex circuit 46 includes conductive traces that mate with conductors 44 and 48. Electrical connections between lines 44 and 48 and the traces of flex circuit 46 are formed from pressure sensitive conductive adhesive 50.

Conductive lines 44 and 48 are formed from screen-printed silver paste. Silver-paste conductive lines exhibit high conductivity, which helps ensure proper operation of the touch sensor.

As shown in the cross-sectional side view of touch sensor 36 of FIG. 3B, flex circuit 46 is connected to circuitry on system board 60 using mating board-to-board connectors 56 and 58. Because there are conductive silver-paste lines 48 and 44 on both sides of glass substrate 38, flex circuit 46 and conductive adhesive 50 must be provided on both sides of glass layer 38, thereby increasing the thickness of sensor 36.

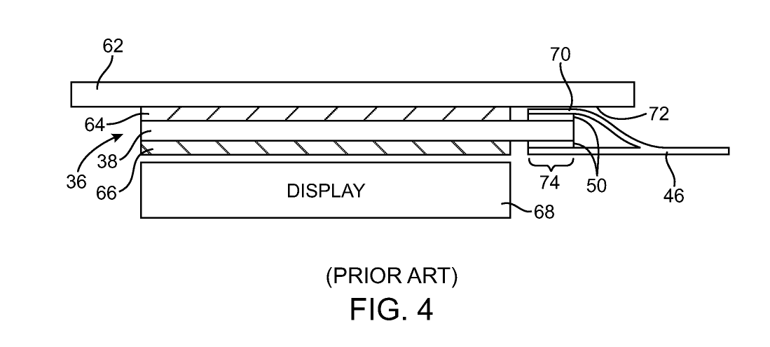

The minimum thickness for sensor 36 is also limited by the need to provide clearance between adjoining material layers. This is illustrated in the cross-sectional side view of touch sensor structure 36 that is shown in FIG. 4. As shown in FIG. 4, conventional touch sensor 36 of FIGS. 3A and 3B is mounted directly on the lower surface of cover glass 62 using adhesive film 64. Adhesive film 64 has sufficient thickness to ensure that top surface 70 of flex circuit 46 does not contact lower surface 72 of cover glass 62. This prevents upper surface 70 of flex circuit 46 from becoming damaged, but requires that adhesive film 64 be relatively thick (0.015 mm). Antireflection (AR) film 66 covers the lower surface of touch sensor 36 to reduce light reflections that might otherwise arise when light from display 68 traverses the air gap between display 68 and touch sensor 36. Antireflection film 66 is 0.11 mm thick. Conductive adhesive 50 is about 10 μm thick. Flex circuit 46 is about 0.12 mm thick. The combined thickness of adhesive 50 and flex circuit 46 leads to a reduction in the area available for mounting components under region 74 of substrate glass 36. The use of adhesive film 50 to connect the traces of flex circuit 46 to the silver-paste traces on the surfaces of glass substrate layer 38 also creates a potential point of failure for touch sensor structures 36 in the event that structures 36 are subjected to shock from an impact event.

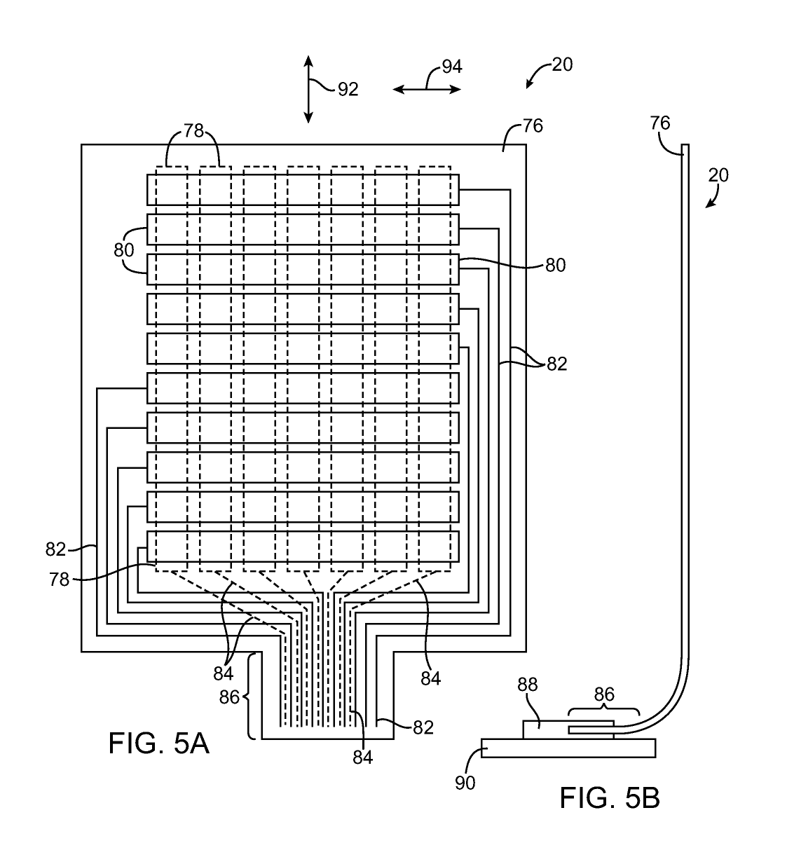

A top view of an illustrative touch sensor structure of the type that may be used in display 14 of device 10 of FIG. 1 is shown in FIG. 5A. As shown in FIG. 5A, touch sensor structure 20 may have a substrate such as substrate 76. Substrate 76 may be formed from a thin layer of plastic or other dielectric. For example, substrate 76 may be formed from a layer of flexible polymer such as a layer of polyimide. Polyimide is commonly used in the electronics industry and is compatible with available semiconductor processing techniques. Polyimide is also compatible with high-conductivity interconnect materials such as copper and transparent conductive electrode materials such as indium-tin oxide. To ensure that light from the display pixels in display 40 can pass through substrate 76 unimpeded, substrate 76 can be formed from clear polyimide. Clear (optical grade) polyimide is available in thin sheets (e.g., sheets having a thickness of about 0.2 mm or less, 0.1 mm or less, etc.) and can be held in place on a frame during processing.

Transparent sensor electrodes can be formed on one or both sides of substrate 76. Transparent sensor electrodes may be formed from a transparent conductive material such as indium-tin oxide or other transparent conductive substance in rows, squares, diagonally oriented groups, or other suitable layouts. In the example of FIG. 5A, the electrodes for touch sensor structure 20 include elongated rectangular electrodes 78 and 80. Electrodes 78 are formed on the rear surface of substrate 76, whereas electrodes 80 are formed on the front surface of substrate 76. Rear surface electrodes 78 may be oriented with their longitudinal axes parallel to vertical axis 92. Electrodes 80 may be oriented with their longitudinal axes parallel to horizontal axis 94.

Conductive paths are formed between electrodes 78 and 80 and tail portion 86 of substrate 76. For example, conductive lines 82 that are connected to respective electrodes 80 may be formed on the front surface of substrate 76, whereas conductive lines 84 that are connected to respective electrodes 78 may be formed on the rear surface of substrate 76. Conductive lines such as lines 82 and 84 may be formed from copper or other suitable conductors. An advantage of using copper to form lines 82 and 84 is that copper is compatible with flexible substrate materials such as polyimide and has a high conductivity. Copper may be deposited by sputtering, evaporation, chemical vapor deposition, screen printing, electroplating, photolithographic patterning techniques, combinations of these fabrication techniques or any other suitable fabrication process. To prevent corrosion, copper lines may be covered with a coating of a corrosion resistant material such as gold.

When substrate 76 is formed from a flexible polymer such as polyimide and is coated with conductive traces such as copper traces, substrate 76 can serve as both a transparent substrate for touch screen electrodes and as a flex circuit path (e.g., all or part of path 34 of FIG. 2) that routes electrode signals to storage and processing circuitry such as storage and processing circuitry 30 (FIG. 2). The flex circuit path portion of substrate 76 may be used to implement a bus with numerous parallel conductive traces. There is no need for a separate flex circuit of the type shown in FIGS. 3A and 3B, thereby reducing complexity and eliminating the need for conductive adhesive film interfaces such as the interfaces provided by conductive adhesive film 50 between conventional flex circuit 46 and the traces on conventional glass substrate 38.

With the unitary flex circuit approach of FIGS. 5A and 5B, traces such as traces 82 and 84 can be coupled directly to a connector on a printed circuit board, eliminating the need for intermediate routing structures. In region 86, substrate 76 (i.e., flex circuit 76) may have a narrowed portion that serves as a tail. This tail portion of substrate 76 may have any suitable length for routing signals within device 10. In a typical configuration, the portion of substrate 76 in region 86 is sufficiently long to allow region 86 to be bent back on itself 180° (e.g., to accommodate attachment of tail 86 to underlying connectors). As shown in FIG. 5B, tail portion 86 of substrate 76 may be received within connector 88 on printed circuit board 90. Printed circuit board 90 may be a main logic board (e.g., a system board), a daughter card, or any other suitable printed circuit board structure. Connector 88 may be, for example, a zero-insertion-force (ZIF) connector or other connector suitable for connecting the conductive traces on substrate 76 to contact pads and interconnect lines on board 90. Connector 88 may include contacts that mate with traces on opposing sides of tail portion 86 or may include contacts that mate with a single side of traces on tail portion 86. In configurations in which tail portion 86 contains single-sided traces, vias may be used to form connections that route signals from traces on one surface of substrate 76 to traces on an opposing surface of substrate 76.

Board 90 may be a rigid or flexible printed circuit board. For example, board 90 may be a main logic board that contains integrated circuits and discrete components for implementing storage and processing circuitry 30 of FIG. 2. Rigid printed circuit boards of the type that may be used for implementing board 90 may be formed from fiberglass-filed epoxy or other dielectrics. Flex circuits for implementing board 90 may be formed from clear or colored polyimide with one or more layers of embedded conductive traces.

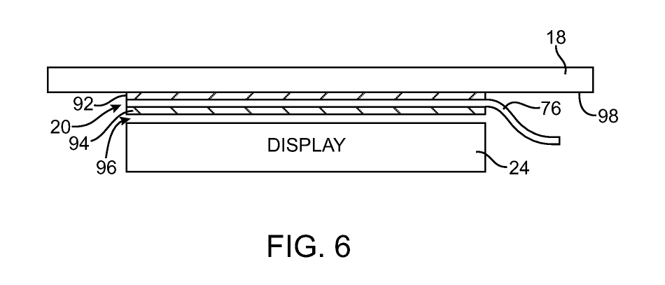

As shown in the cross-sectional diagram of FIG. 6, flexible transparent substrate 76 of touch sensor structure 20 may be mounted to lower surface 98 of cover glass 18 using a layer of adhesive such as adhesive 92. Adhesive 92 may be a clear pressure sensitive adhesive (PSA), a thermally cured epoxy, an epoxy that is cured by application of ultraviolet light through cover glass 18, or other suitable adhesive. Substrate 76 can bend down and away from lower surface 98 of cover glass 18, so there is no need to create an excessive offset between the upper surface of substrate 76 and lower surface 98 of cover glass 18. Because there is no need to create a substantial offset between the lower surface of cover glass 18 and the upper surface of flex circuit substrate 76, adhesive layers such as adhesive layer 92 in arrangements of the type shown in FIG. 6 can be thinner than conventional adhesive layers such as adhesive layer 64 of FIG. 4. For example, layer 92 may be as thin as 100 μm or less, 50 μm or less, or even 10 μm or less, provided that layer 92 has sufficient thickness to attach substrate 76 to cover glass 18 without bubbles. Substrate 76 can also be made thinner than conventional flex circuits because flex circuit 76 does not need to withstand the stress that is associated with forming conductive adhesive connections (as shown with conventional conductive adhesive 50 and flex circuit 46 of FIG. 3B). For example, substrate 76 may be about 0.1 mm in thickness.

The lower surface of touch sensor structure 20 may be coated with antireflection layer 94 to reduce reflections that might otherwise arise from the presence of air gap 96 as light exits the surface of display 24.

Layer 94 may be an antireflection (AR) film such as a polyethylene terephthalate (PET) film or other clear polymer. An AR polymer film that is used for antireflection film layer 94 may have a thickness of about 0.11 mm (as an example) and may have an index of refraction n having a value that lies between that of air (n=1) and substrate 76 (e.g., n=1.4-1.5).

Layer 94 may also be formed by depositing thinner layers of material. For example, layer 94 may be formed form a layer of silicon oxide, a layer of titanium oxide, a layer of a unidirectional nano-structured coating, or other transparent coating that has a thickness of a fraction of a wavelength (e.g., 1 μm or less).

By potentially reducing the thicknesses of adhesive layer 92, touch sensor substrate layer 76, and/or antireflection coating layer 96, the overall thickness of touch sensor structure 20 may be reduced considerably relative to conventionally constructed touch sensor structures.

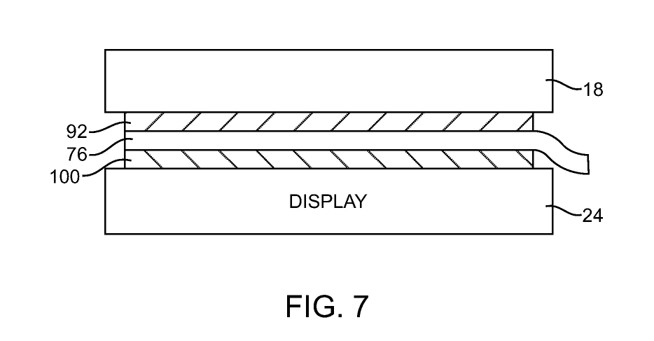

FIG. 7 shows how the need for antireflection layer 94 can be reduced or eliminated by attaching substrate 76 directly to the upper surface of display module 24 using adhesive 100. Adhesive 100 may be a clear adhesive such as a clear pressure sensitive adhesive, UV or thermally cured adhesive, etc. The upper surface of display module 24 may be a planar member such as a layer of encapsulation glass.

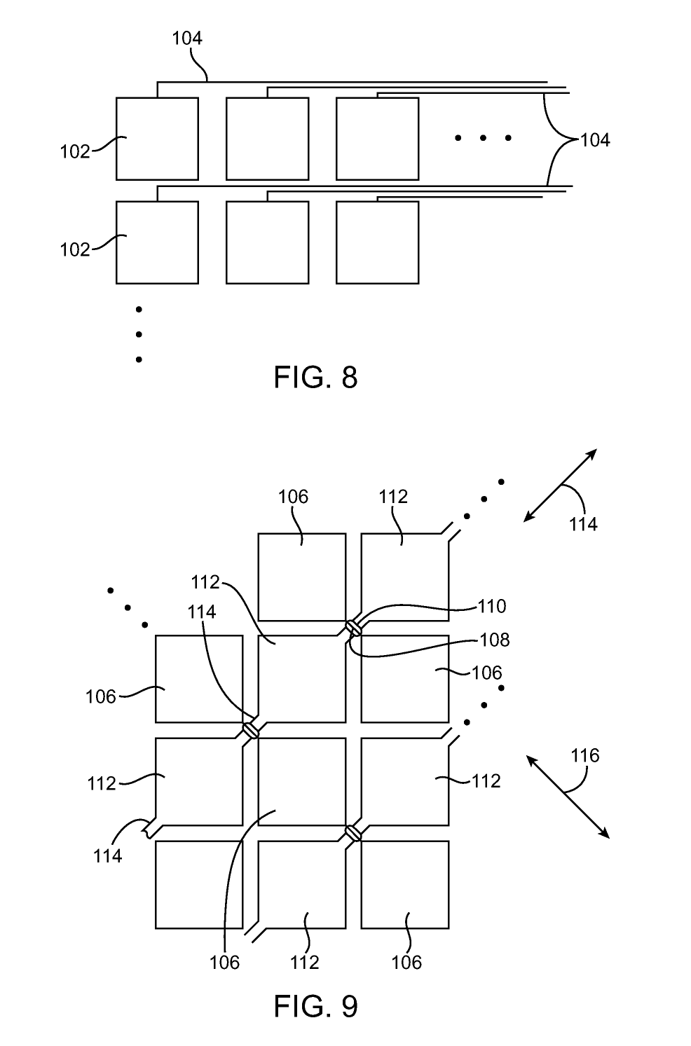

If desired, the transparent conductive structures that are used as capacitive touch screen electrodes may be formed on a single side of substrate 76. As shown in FIG. 8, for example, square touch sensor electrodes 102 (e.g., ITO traces) may be arranged in rows and columns on the front side of substrate 76. Conductive traces 104 such as gold-coated copper traces may be used to route signals from electrodes 102 to the edge of the substrate (e.g., to tail region 86 of FIG. 5A).

As shown in FIG. 9, electrodes on substrate 76 may be formed in diagonal groups. Once set of groups includes diagonally connected electrodes 112, which run parallel to diagonal axis 114. Another set of groups includes diagonally connected electrodes 106, which run parallel to diagonal axis 116. Within each diagonal electrode group, conductive paths are used to connect successive electrodes. For example, each electrode 112 is connected to a diagonally adjacent electrode 112 through an associated conductive path 114. Electrodes 106 may be connected to diagonally adjacent electrodes 106 using conductors 108. Insulating pads 110 may be used to allow conductors 108 to pass over conductors 114 without creating a short circuit. Pads 110 may be formed using polymers, oxides, or other suitable dielectrics.

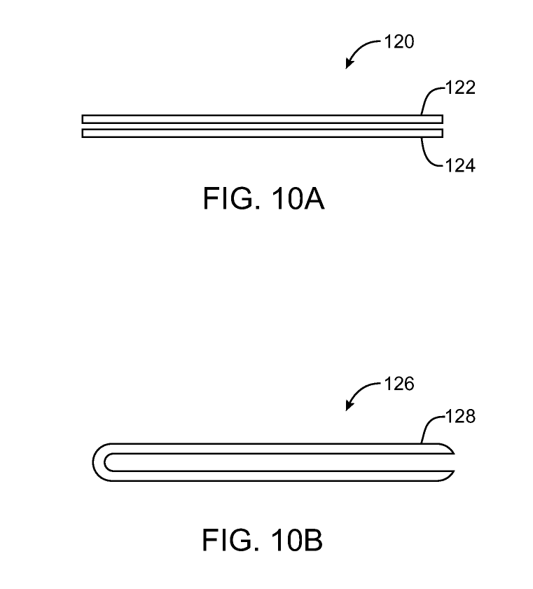

FIGS. 10a and 10b are simplified diagrams of a layered touch substrate, in accordance with one embodiment. The layered touch substrate arrangement may include multiple touch substrates that are stacked, such as in the example of FIG. 10A. Stacked substrates 120 of FIG. 10A may have substrates 122 and 124. The touch substrates 122 and 124 may for example be any of those described in the previous embodiments. In one embodiment, the stacked substrate includes multiple glass based substrates. In another embodiment, the stacked substrate includes multiple polymer based substrates. In another embodiment, the stacked substrate includes at least one glass substrate and one polymer based substrate. The desired arrangement may depend on the desired configuration of the touch sensing. Further, the multiple stack 120 is not limited to two and may include more than two, again depending on the needs of the touch system. As shown in FIG. 10b, a polymer based substrate 128 may be folded over to create stacked substrate 126. As such the sensors can be disposed on a single substrate 128 that forms multiple layers. Each fold cooperates with the other fold to create the desired touch sensing effect. In some cases, an intermediate layer can be disposed between the two folded layers. In some cases, the folded layers have the same shape and dimensions. In other cases, they have different shapes and dimensions. In some cases, the upper layer covers the entire lower layer while in other cases the upper layer only covers a portion of the lower layer. The upper layer may not even cover the lower layer at all. The configuration of the sensors may be designed to be spaced apart from other sensors such that they cooperate to form a touch area. In other cases, the sensors may overlap partially or entirely. Of course, each of the layers may include different components, for example, the upper layer may include touch sensors while the lower layer may include other forms of sensors or output mechanisms such a light sources or display elements or haptic elements. Additionally, the layers may include a portion of the above.

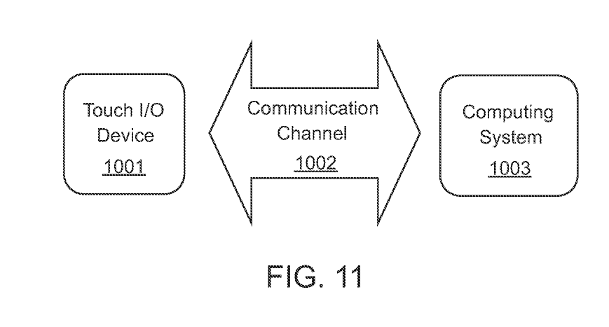

Described embodiments may include touch I/O device 1001 that can receive touch input for interacting with computing system 1003 (FIG. 11) via wired or wireless communication channel 1002. Touch I/O device 1001 may be used to provide user input to computing system 1003 in lieu of or in combination with other input devices such as a keyboard, mouse, etc. One or more touch I/O devices 1001 may be used for providing user input to computing system 1003. Touch I/O device 1001 may be an integral part of computing system 1003 (e.g., touch screen on a laptop) or may be separate from computing system 1003.

Touch I/O device 1001 may include a touch sensitive panel which is wholly or partially transparent, semitransparent, non-transparent, opaque or any combination thereof. Touch I/O device 1001 may be embodied as a touch screen, touch pad, a touch screen functioning as a touch pad (e.g., a touch screen replacing the touchpad of a laptop), a touch screen or touchpad combined or incorporated with any other input device (e.g., a touch screen or touchpad disposed on a keyboard) or any multi-dimensional object having a touch sensitive surface for receiving touch input.

In one example, touch I/O device 1001 embodied as a touch screen may include a transparent and/or semitransparent touch sensitive panel partially or wholly positioned over at least a portion of a display. According to this embodiment, touch I/O device 1001 functions to display graphical data transmitted from computing system 1003 (and/or another source) and also functions to receive user input. In other embodiments, touch I/O device 1001 may be embodied as an integrated touch screen where touch sensitive components/devices are integral with display components/devices. In still other embodiments a touch screen may be used as a supplemental or additional display screen for displaying supplemental or the same graphical data as a primary display and to receive touch input.

Touch I/O device 1001 may be configured to detect the location of one or more touches or near touches on device 1001 based on capacitive, resistive, optical, acoustic, inductive, mechanical, chemical measurements, or any phenomena that can be measured with respect to the occurrences of the one or more touches or near touches in proximity to device 1001. Software, hardware, firmware, or any combination thereof may be used to process the measurements of the detected touches to identify and track one or more gestures. A gesture may correspond to stationary or non-stationary, single or multiple, touches or near touches on touch I/O device 1001. A gesture may be performed by moving one or more fingers or other objects in a particular manner on touch I/O device 1001 such as tapping, pressing, rocking, scrubbing, twisting, changing orientation, pressing with varying pressure and the like at essentially the same time, contiguously, or consecutively. A gesture may be characterized by, but is not limited to a pinching, sliding, swiping, rotating, flexing, dragging, or tapping motion between or with any other finger or fingers. A single gesture may be performed with one or more hands, by one or more users, or any combination thereof.

Computing system 1003 may drive a display with graphical data to display a graphical user interface (GUI). The GUI may be configured to receive touch input via touch I/O device 1001. Embodied as a touch screen, touch I/O device 1001 may display the GUI. Alternatively, the GUI may be displayed on a display separate from touch I/O device 1001. The GUI may include graphical elements displayed at particular locations within the interface. Graphical elements may include but are not limited to a variety of displayed virtual input devices including virtual scroll wheels, a virtual keyboard, virtual knobs, virtual buttons, any virtual UI, and the like. A user may perform gestures at one or more particular locations on touch I/O device 1001 which may be associated with the graphical elements of the GUI. In other embodiments, the user may perform gestures at one or more locations that are independent of the locations of graphical elements of the GUI. Gestures performed on touch I/O device 1001 may directly or indirectly manipulate, control, modify, move, actuate, initiate or generally affect graphical elements such as cursors, icons, media files, lists, text, all or portions of images, or the like within the GUI. For instance, in the case of a touch screen, a user may directly interact with a graphical element by performing a gesture over the graphical element on the touch screen. Alternatively, a touch pad generally provides indirect interaction. Gestures may also affect non-displayed GUI elements (e.g., causing user interfaces to appear) or may affect other actions within computing system 1003 (e.g., affect a state or mode of a GUI, application, or operating system). Gestures may or may not be performed on touch I/O device 1001 in conjunction with a displayed cursor. For instance, in the case in which gestures are performed on a touchpad, a cursor (or pointer) may be displayed on a display screen or touch screen and the cursor may be controlled via touch input on the touchpad to interact with graphical objects on the display screen. In other embodiments in which gestures are performed directly on a touch screen, a user may interact directly with objects on the touch screen, with or without a cursor or pointer being displayed on the touch screen.

Feedback may be provided to the user via communication channel 1002 in response to or based on the touch or near touches on touch I/O device 1001. Feedback may be transmitted optically, mechanically, electrically, olfactory, acoustically, or the like or any combination thereof and in a variable or non-variable manner.

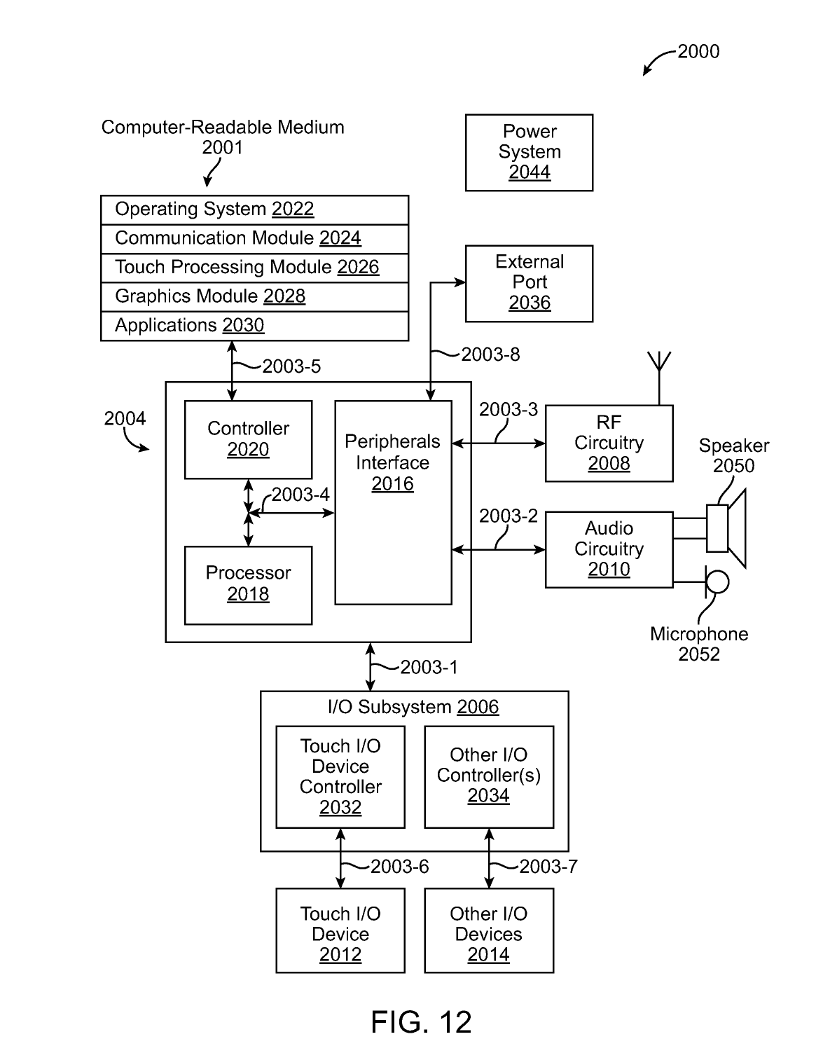

Attention is now directed towards embodiments of a system architecture that may be embodied within any portable or non-portable device including but not limited to a communication device (e.g. mobile phone, smart phone), a multi-media device (e.g., MP3 player, TV, radio), a portable or handheld computer (e.g., tablet, netbook, laptop), a desktop computer, an All-In-One desktop, a peripheral device, or any other system or device adaptable to the inclusion of system architecture 2000, including combinations of two or more of these types of devices. FIG. 12 is a block diagram of one embodiment of system 2000 that generally includes one or more computer-readable mediums 2001, processing system 2004, Input/Output (I/O) subsystem 2006, radio frequency (RF) circuitry 2008, and audio circuitry 2010. These components may be coupled by one or more communication buses or signal lines 2003.

It should be apparent that the architecture shown in FIG. 12 is only one example architecture of system 2000, and that system 2000 could have more or fewer components than shown, or a different configuration of components. The various components shown in FIG. 12 can be implemented in hardware, software, firmware or any combination thereof, including one or more signal processing and/or application specific integrated circuits.

RF circuitry 2008 is used to send and receive information over a wireless link or network to one or more other devices and includes well-known circuitry for performing this function. RF circuitry 2008 and audio circuitry 2010 are coupled to processing system 2004 via peripherals interface 2016. Interface 2016 includes various known components for establishing and maintaining communication between peripherals and processing system 2004. Audio circuitry 2010 is coupled to audio speaker 2050 and microphone 2052 and includes known circuitry for processing voice signals received from interface 2016 to enable a user to communicate in real-time with other users. In some embodiments, audio circuitry 2010 includes a headphone jack (not shown).

Peripherals interface 2016 couples the input and output peripherals of the system to processor 2018 and computer-readable medium 2001. One or more processors 2018 communicate with one or more computer-readable mediums 2001 via controller 2020. Computer-readable medium 2001 can be any device or medium that can store code and/or data for use by one or more processors 2018. Medium 2001 can include a memory hierarchy, including but not limited to cache, main memory, and secondary memory. The memory hierarchy can be implemented using any combination of RAM (e.g., SRAM, DRAM, DDRAM), ROM, FLASH, magnetic and/or optical storage devices, such as disk drives, magnetic tape, CDs (compact disks) and DVDs (digital video discs). Medium 2001 may also include a transmission medium for carrying information-bearing signals indicative of computer instructions or data (with or without a carrier wave upon which the signals are modulated). For example, the transmission medium may include a communications network, including but not limited to the Internet (also referred to as the World Wide Web), intranet(s), Local Area Networks (LANs), Wide Local Area Networks (WLANs), Storage Area Networks (SANs), Metropolitan Area Networks (MAN), and the like.

One or more processors 2018 run various software components stored in medium 2001 to perform various functions for system 2000. In some embodiments, the software components include operating system 2022, communication module (or set of instructions) 2024, touch processing module (or set of instructions) 2026, graphics module (or set of instructions) 2028, and one or more applications (or set of instructions) 2030. Each of these modules and above noted applications correspond to a set of instructions for performing one or more functions described above and the methods described in this application (e.g., the computer-implemented methods and other information processing methods described herein). These modules (i.e., sets of instructions) need not be implemented as separate software programs, procedures, or modules, and thus various subsets of these modules may be combined or otherwise re-arranged in various embodiments. In some embodiments, medium 2001 may store a subset of the modules and data structures identified above. Furthermore, medium 2001 may store additional modules and data structures not described above.

Operating system 2022 includes various procedures, sets of instructions, software components, and/or drivers for controlling and managing general system tasks (e.g., memory management, storage device control, power management, etc.) and facilitates communication between various hardware and software components.

Communication module 2024 facilitates communication with other devices over one or more external ports 2036 or via RF circuitry 2008 and includes various software components for handling data received from RF circuitry 2008 and/or external port 2036.

Graphics module 2028 includes various known software components for rendering, animating and displaying graphical objects on a display surface. In embodiments in which touch I/O device 2012 is a touch sensitive display (e.g., touch screen), graphics module 2028 includes components for rendering, displaying, and animating objects on the touch sensitive display.

One or more applications 2030 can include any applications installed on system 2000, including without limitation, a browser, address book, contact list, email, instant messaging, word processing, keyboard emulation, widgets, JAVA-enabled applications, encryption, digital rights management, voice recognition, voice replication, location determination capability (such as that provided by the global positioning system (GPS)), a music player, etc.

Touch processing module 2026 includes various software components for performing various tasks associated with touch I/O device 2012 including but not limited to receiving and processing touch input received from I/O device 2012 via touch I/O device controller 2032.

I/O subsystem 2006 is coupled to touch I/O device 2012 and one or more other I/O devices 2014 for controlling or performing various functions. Touch I/O device 2012 communicates with processing system 2004 via touch I/O device controller 2032, which includes various components for processing user touch input (e.g., scanning hardware). One or more other input controllers 2034 receives/sends electrical signals from/to other I/O devices 2014. Other I/O devices 2014 may include physical buttons, dials, slider switches, sticks, keyboards, touch pads, additional display screens, or any combination thereof.

If embodied as a touch screen, touch I/O device 2012 displays visual output to the user in a GUI. The visual output may include text, graphics, video, and any combination thereof. Some or all of the visual output may correspond to user-interface objects. Touch I/O device 2012 forms a touch-sensitive surface that accepts touch input from the user. Touch I/O device 2012 and touch screen controller 2032 (along with any associated modules and/or sets of instructions in medium 2001) detects and tracks touches or near touches (and any movement or release of the touch) on touch I/O device 2012 and converts the detected touch input into interaction with graphical objects, such as one or more user-interface objects. In the case in which device 2012 is embodied as a touch screen, the user can directly interact with graphical objects that are displayed on the touch screen. Alternatively, in the case in which device 2012 is embodied as a touch device other than a touch screen (e.g., a touch pad), the user may indirectly interact with graphical objects that are displayed on a separate display screen embodied as I/O device 2014.

Touch I/O device 2012 may be analogous to the multi-touch sensitive surface described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference.

Embodiments in which touch I/O device 2012 is a touch screen, the touch screen may use LCD (liquid crystal display) technology, LPD (light emitting polymer display) technology, OLED (organic LED), or OEL (organic electro luminescence), although other display technologies may be used in other embodiments.

Feedback may be provided by touch I/O device 2012 based on the user's touch input as well as a state or states of what is being displayed and/or of the computing system. Feedback may be transmitted optically (e.g., light signal or displayed image), mechanically (e.g., haptic feedback, touch feedback, force feedback, or the like), electrically (e.g., electrical stimulation), olfactory, acoustically (e.g., beep or the like), or the like or any combination thereof and in a variable or non-variable manner.

System 2000 also includes power system 2044 for powering the various hardware components and may include a power management system, one or more power sources, a recharging system, a power failure detection circuit, a power converter or inverter, a power status indicator and any other components typically associated with the generation, management and distribution of power in portable devices.

In some embodiments, peripherals interface 2016, one or more processors 2018, and memory controller 2020 may be implemented on a single chip, such as processing system 2004. In some other embodiments, they may be implemented on separate chips.

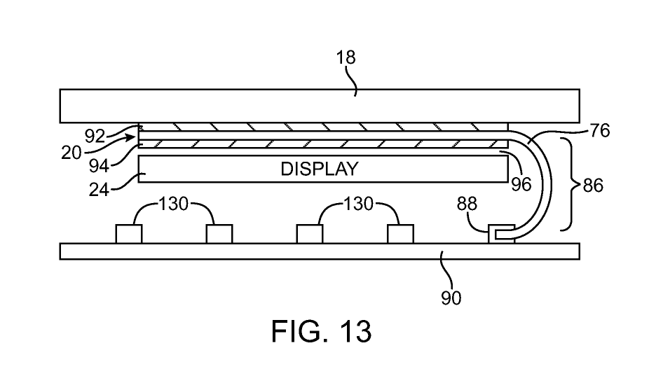

As shown in the cross-sectional diagram of FIG. 13, substrate 76 (i.e., flex circuit 76) may have tail portion 86 that bends back on itself by 180°. Substrate 76 also has a planar portion with capacitive electrodes that may be attached by adhesive 92 to cover glass 18. Display 24 may be separated from substrate 24 by a gap, or display 24 may be attached directly to substrate 24. If display 24 is separated from substrate 24 by a gap, the lower surface of touch sensor structure 20 may be coated with antireflection layer 94 to reduce reflections that might otherwise arise from the presence of air gap 96 as light exits the surface of display 24.

Curved (bent) tail portion 86, which is an integral portion of substrate 76, does not generally lie in the plane of cover glass 18 and is therefore not coplanar with the planar portion of substrate 76. Tail portion 86 may be received within connector 88 on printed circuit board 90. Printed circuit board 90 may be a main logic board (e.g., a system board), a daughter card, or any other suitable printed circuit board structure. Connector 88 may be, for example, a zero-insertion-force (ZIF) connector or any other suitable connector. Connector 88 may include contacts that mate with traces on opposing sides of tail portion 86 or may include contacts that mate with a single side of traces on tail portion 86. In configurations in which tail portion 86 contains single-sided traces, vias may be used to form connections that route signals from traces on one surface of substrate 76 to traces on an opposing surface of substrate 76. In lieu of connector 88, tail portion 86 may be attached with to printed circuit board 90 using conductive adhesive or solder joints.

Printed circuit board 90 may be a rigid or flexible printed circuit board. Printed circuit board 90 may be parallel to cover glass 18. For example, board 90 may be a main logic board that contains components 130 such as integrated circuits and discrete components implementing storage and processing circuitry 30 of FIG. 2. The structures of FIG. 13 may be mounted within housing 12 of device 10 (FIG. 1).

The foregoing is merely illustrative of the principles of this invention and various modifications can be made by those skilled in the art without departing from the scope and spirit of the invention.

What is claimed is:

1. A touch sensor structure in a touch screen, comprising:
a clear flexible polymer substrate;
transparent capacitive touch sensor electrodes formed on the flexible polymer substrate; and
metal traces on the clear flexible polymer substrate that are electrically connected to the transparent capacitive touch sensor electrodes.

2. The touch sensor structure defined in claim 1, wherein the clear flexible polymer substrate comprises:
a planar portion on which the transparent capacitive touch sensor electrodes are formed; and
a bent tail portion on which no transparent capacitive touch sensor electrodes are formed.

3. The touch sensor structure defined in claim 2, wherein the bent tail portion of the clear flexible polymer substrate includes at least some of the metal traces and is not coplanar with the planar portion.

4. The touch sensor structure defined in claim 2 wherein the bent tail portion of the clear flexible polymer substrate includes at least some of the metal traces and wherein the metal traces comprise copper traces.

5. The touch sensor structure defined in claim 2 wherein the bent tail portion of the clear flexible polymer substrate is connected to a printed circuit board.

6. The touch sensor structure defined in claim 2 wherein the metal traces on the clear flexible polymer substrate comprise copper traces on the bent tail portion of the clear flexible polymer substrate that are electrically connected to a printed circuit board.

7. The touch sensor structure defined in claim 2 wherein the bent tail portion of the clear flexible polymer substrate is narrower than the planar portion of the clear flexible polymer substrate.

8. The touch sensor structure defined in claim 1 wherein the transparent capacitive touch sensor electrodes are rectangular and are formed in rows and columns on the clear flexible polymer substrate.

9. The touch sensor structure defined in claim 8 wherein the capacitive touch sensor electrodes are formed on opposing sides of the clear flexible polymer substrate.

10. The touch sensor structure defined in claim 1 wherein the metal traces are formed on two opposing sides of the clear flexible polymer substrate.

11. The touch sensor structure defined in claim 10 wherein the clear flexible polymer comprises clear polyimide.

12. A touch sensor structure in a touch screen, comprising:
a transparent polymer substrate having front and rear surfaces; and
transparent capacitive touch sensor electrodes formed on the front and rear surfaces of the transparent polymer substrate.

13. The touch sensor structure defined in claim 12 wherein the transparent polymer substrate comprises a flexible transparent polymer substrate.

14. The touch sensor structure defined in claim 12 wherein the transparent polymer substrate comprises a transparent polyimide substrate.

15. The touch sensor structure defined in claim 12 wherein the transparent capacitive touch sensor electrodes comprises parallel strips of transparent conductive material on the front and rear surfaces, and wherein the parallel strips on the front surface of the transparent polymer substrate are perpendicular to the parallel strips on the rear surface of the transparent polymer substrate.

16. An electronic device, comprising:
a transparent flexible polymer substrate having front and rear surfaces; and
transparent indium-tin oxide capacitive touch sensor electrodes formed on the front and rear surfaces of the transparent flexible polymer substrate.

17. The electronic device defined in claim 16 further comprising copper traces on the transparent flexible polymer substrate.

18. The electronic device defined in claim 16 wherein the transparent flexible polymer substrate comprises a planar portion and a non-planar portion and wherein the transparent indium-tin oxide capacitive touch sensor electrodes are formed on the planar portion and are not formed on the non-planar portion.

19. The electronic device defined in claim 18 further comprising a printed circuit board, wherein the non-planar portion of the transparent flexible polymer substrate is connected to the printed circuit board.

20. The electronic device defined in claim 16, wherein the transparent flexible polymer substrate comprises a planar portion and a non-planar portion and wherein the electronic device further comprises:
a connector; and
a printed circuit board on which the connector is mounted, wherein the non-planar portion of the transparent flexible polymer substrate is inserted into the connector.

21. The electronic device defined in claim 16 further comprising:
a cover glass, wherein the front surface of the transparent flexible polymer substrate is connected with adhesive to the cover glass.

22. The electronic device defined in claim 16 further comprising:
a display that is separated from the rear surface of the transparent flexible polymer substrate by a gap and wherein an antireflective layer is formed on the rear side of the transparent flexible polymer substrate.

23. The electronic device defined in claim 16 further comprising:
a display, wherein the rear surface of the transparent flexible polymer substrate is connected with adhesive to the display.
